(19) United States
(12) Patent Application Publication
(10) Pub. No.: US 2007/0231141 A1
(43) Pub. Date: Oct. 4, 2007

(54) Radial turbine wheel with locally curved trailing edge tip

(75) Inventors: Wei-Shing Chaing, Diamond Bar, CA (US); Frank F. Lin, Torrance, CA (US); Shioping P. Oyoung, Fullerton, CA (US); Robert P. Chen, Torrance, CA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC.

(21) Appl. No.: 11/395,629

(22) Filed: Mar. 31, 2006

(51) Int. Cl. F03B 7/00

(52) U.S. Cl. 416/185

(57) ABSTRACT

The present invention provides a turbine wheel with locally curved trailing edge blade tips on the blades of the turbine wheel. The locally curved trailing edge may increase the blade vibration mode natural frequency which may in turn result in longer blade fatigue lifetimes. It may also eliminate vortex shedding. Methods for increasing the blade vibration mode natural frequencies using the turbine wheel of the present invention are also provided.

### BACKGROUND OF THE INVENTION

This invention relates generally to radial turbine wheels and more specifically to radial turbine wheels having blades with locally curved trailing edge tips.

High cycle fatigue of turbine wheel blades is a significant design problem because fatigue failure can result from resonant vibratory stresses sustained over a relatively short time. Fatigue failure results from a combination of steady stress and vibratory stress. The root cause of vibratory stress is flow-induced vibration at blade resonant frequency interfering with nozzle/vane passage frequency expressed in N per revolution with N=1, 2 . . . etc. For avoidance of high cycle fatigue failure due to vibratory stress, it would be preferable if the wheel has all blade vibration frequencies high enough that clears the vane count in the operating speed region.

The prior art has attempted to reduce stresses on the turbine wheel blades by configuring blade geometry. In one turbine blade, the leading edge geometry is a very slender ellipse or parabola and includes a serrated structure, pocket-type depressions, or a recessed area acting as a sweep back. In another example, an area of roughness is incorporated into the blade close to the leading edge. While both these blades have reduced vibrational stress, both incorporate areas that must be machined into the blade and are not easily manipulated once the blade has been made.

As can be seen, there is a need for radial turbine wheels having blades with decreased vibrational stresses resulting in increased blade life. It would also be desirable if the blades were easy and cost effective to manufacture.

### SUMMARY OF THE INVENTION

In one aspect of the present invention there is provided a turbine wheel comprising a hub; a central bore running longitudinally through the hub; at least one blade, the blade extending radially from the hub and wherein the blade comprises a blade tip, the blade tip comprising a trailing edge; and wherein the trailing edge of the blade tip is locally curved.

In another aspect of the present invention there is provided a turbine wheel comprising: a hub; a central bore running longitudinally through the hub; long splitters and short splitter, the long and short splitters extending radially from the hub; a plurality of blades, the blades extending radially from the hub and being separated from one another by the long and short splitter, wherein the blade comprises a blade tip, the blade tip comprising a trailing edge; and wherein the trailing edge of the blade tip is curved.

In a further aspect of the present invention there is provided a method for increasing the natural frequency in a blade vibrating mode of blades of a turbine wheel comprising the steps of: (a) clipping the trailing edges of blade tips of the blades to form a circular or polynomial arc; (b) predicting the natural frequency of blade vibrating modes by using a finite element model of the modified turbine wheel; (c) determining the actual natural frequency of blade vibration modes by testing the modified turbine wheel; and (d) comparing the actual natural frequency to the predicted natural frequency.

These and other features, aspects and advantages of the present invention will become better understood with reference to the following drawings, description and claims.

### BRIEF DESCRIPTION OF THE DRAWINGS

FIG. 1 is a side view of a radial turbine wheel, according to the present invention;

FIG. 2 is a bottom view of a radial turbine wheel, according to the present invention;

FIG. 3 is an isometric view of a radial turbine wheel, according to the present invention;

FIG. 4 is a meridional view showing the description of the blade in an axial-radial coordinate system.

FIG. 5 is a finite element model plot showing the natural frequencies and vibratory stress plot of a turbine wheel blade according to the present invention;

FIG. 6 a finite element model plot showing the steady stress distribution plot of a turbine wheel blade according to the present invention; and

FIG. 7 is a flow chart illustrating a method for increasing the blade bending natural frequency of a turbine wheel blade, according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides a turbine wheel comprising blades having a locally curved trailing edge tip. The present invention also provides methods of using the turbine wheel of the present invention to control blade natural frequencies which may result in increased fatigue life of the blades and may also eliminate vortex shedding. The turbine wheel of the present invention may be used in gas turbine engines for applications in, but not limited to, aerospace.

The present invention provides a turbine wheel which may have increased blade fatigue life and no or reduced vortex shedding. This may be accomplished by having a locally curved trailing edge tip on the blade itself. The prior art provides blades for turbine wheels having modifications at the leading edge. These prior art modifications include providing areas of roughness on the surface of blade, indentations or recessed areas and changes in the geometry of the leading edge. In contrast, the present invention provides a locally curved blade edge tip at the trailing edge of blade.

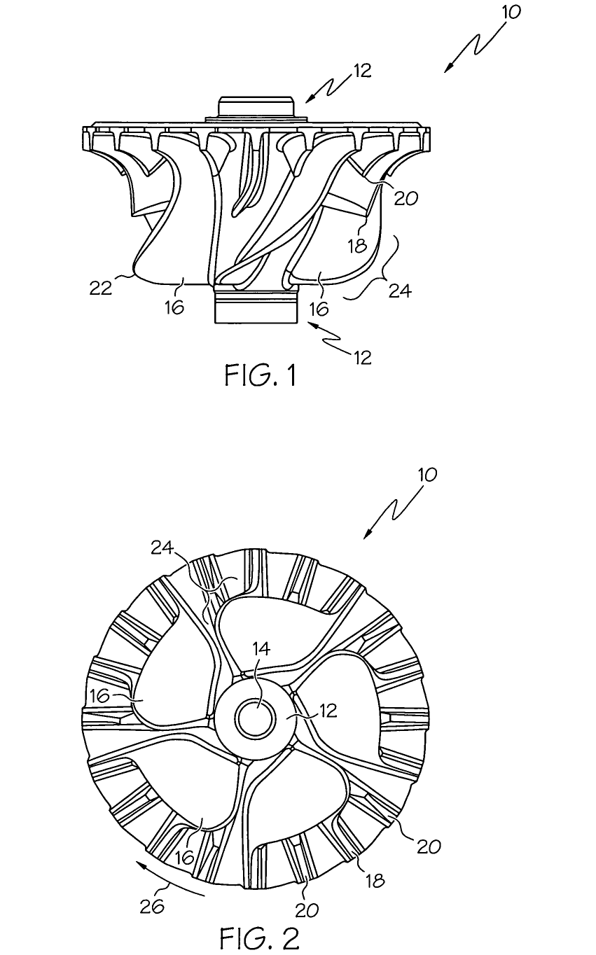

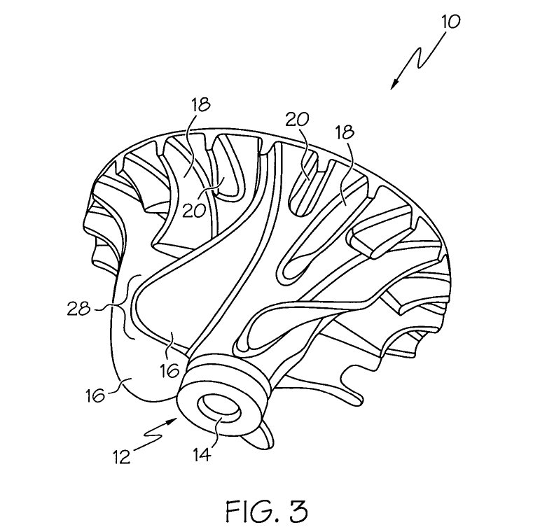

Referring to FIGS. 1-3, turbine wheel 10 may comprise a hub 12 with a central bore 14 running longitudinally through hub 12. The central bore 14 may be used to mounting of turbine wheel 10 on a shaft (not shown). Extending radially from hub 12 there may be at least one blade 16 and long 18 and short 20 splitters, where the long 18 and short 20 splitters are dispersed between multiple blades 16. There may be a plurality of blades 16 separated from one another by long 18 and short 20 splitters. By way of non-limiting example, turbine wheel 10 may have at least five blades 16, five long splitters 18 and/or ten short splitters 20.

Blade 16 may comprise a blade tip 24 and blade tip 24 may comprise a trailing edge 22 with respect to the direction of rotation 26 of turbine wheel 10. Blade tip 24 may be the part of blade 16 that intersects with an outer shroud (not shown). Trailing edge 22 of blade tip 24 may be locally curved as shown in FIGS. 1-3.

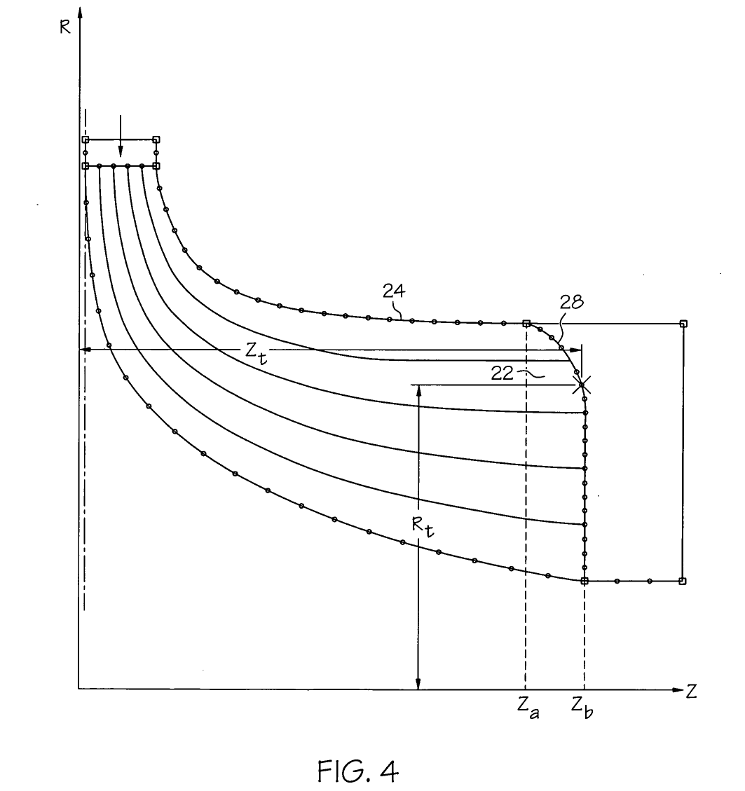

Referring to FIG. 4, the curvature of shroud line of blade tip 24 at trailing edge 22 showing on the meridional view may be defined as:
R=aₙ×Zⁿaₙ₋₁×Zⁿ⁻¹+ . . . +a×Z+b

where:
Z is an axial coordinate of a shroud line on meridional view and zₐ≦Z≦z_{b}
R is a radial coordinate of the shroud line on meridional view.
n is order of polynomial n=2, 3, 4.
aₙ and b are constants
zₐ is a start point of polynomial arc on axial coordinate
z_{b} is a end point of polynomial arc on axial coordinate

This curvature of trailing edge 22 may control blade frequency for low order modes of resonance which may result in increased fatigue life and the elimination of vortex shedding.

The curvature of trailing edge 22 may be characterized by circular or polynomial arc 28. By adjusting the curvature of circular or polynomial arc 28 of trailing edge 22, blade 16 may achieve frequency avoidance for low order modes resonance. The amount of curvature of circle arc 28 may be determined empirically. All blades 16 may be clipped at the same time to give locally curved trailing edge 22 of blade tip 24 and then the frequency of blades 16 may be monitored. It may then be determined whether additional clipping is necessary to produce the proper frequency adjustment. It may be preferable to clip blade tip 24 in small increments to avoid over-clipping of blade tip 24. Over clipping may lead to a decrease in aerodynamic and/or structural performance.

By way of non-limiting example, when turbine wheel 10, as depicted for illustrative purposes in FIGS. 1-3, was tested before curving trailing edge 22 of blade tip 24, the natural frequency in the first blade bending mode was less than 5 per revolution in the operating speed range. Over a period of time, operating at this frequency may lead to decreased blade fatigue life. After clipping trailing edges 22 of blade tips 24, the natural frequency was increased to an acceptable level, i.e. greater than 5 per revolution in the operating speed range. Additionally, when the natural frequency in the first blade blending mode is increased, the subsequent second, third and higher blade vibration mode natural frequencies may increase also. The natural frequency for the first blade bending mode may be increased from 5 per revolution to 17 per revolution. The natural frequency may further be increased, but not limited to, from 11 per revolution to 17 per revolution for the second torsion mode. It will be appreciated that these values are only for illustrative purposes and the exact values will vary based on the actual geometry of turbine wheel 10 and the operation conditions of the turbine engine.

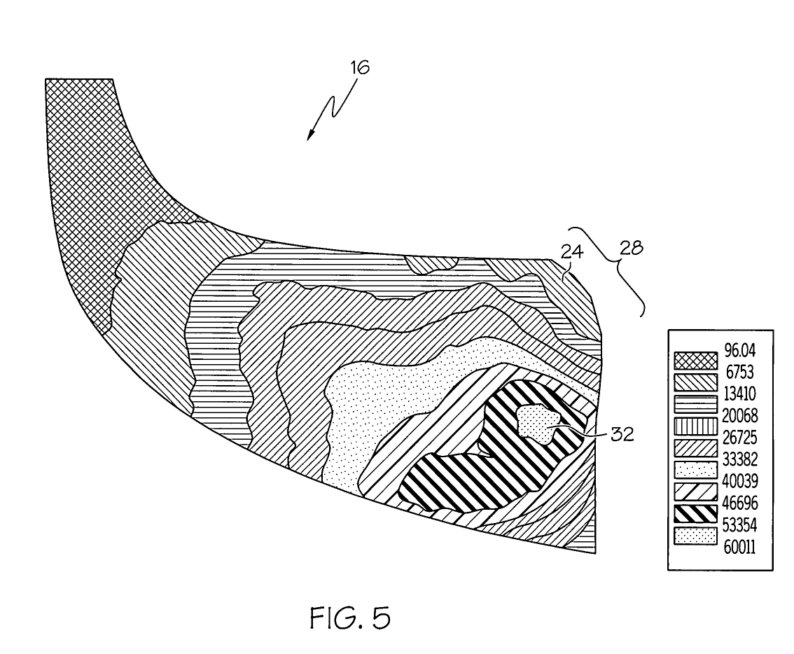

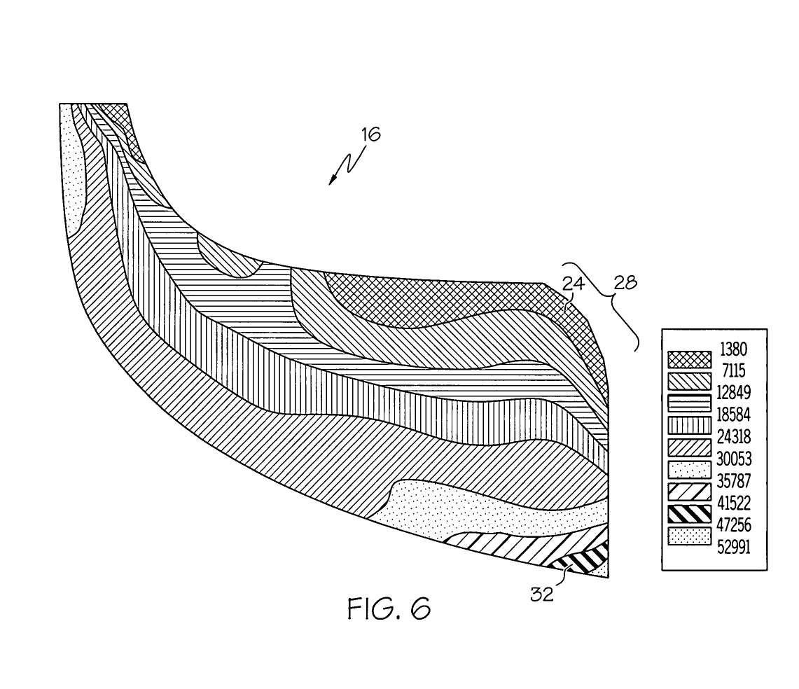

The fatigue failure of turbine wheel blade 16 may result from a combination of steady stress and vibratory stress of blade 16. For avoidance of failure due to high cycle fatigue, a maximum steady stress location 32 (see FIG. 6) may have less vibratory stress or the maximum vibratory stress location 31 (see FIG. 5) may have less steady stress. Additionally, turbine wheel blade 16 may have the steady stress low enough that the combination stress is less than the blade material endurance limit during the blade resonance. The root cause of steady stress may be induced by centrifugal force arising from the mass of turbine wheel blade 16 rotating about a wheel axis.

By way of non-limiting example, when turbine wheel 10, as depicted for illustrative purposes in FIGS. 5-6, was tested before curving trailing edge 22 of blade tip 24, the combination stress of steady stress and vibratory stress in the first blade bending mode was too high at the resonant speed (not shown). Over a period of time, operating at this stress may lead to decreased blade fatigue life. After clipping trailing edges 22 of blade tips 24, the maximum steady stress location 32 (FIG. 6) was decreased to an acceptable level due to less mass on blade, i.e. the combination stress lower than material endurance limit at the resonant speed. Additionally, when the natural frequency in the first blade blending mode is increased, the maximum vibratory stress location 31 (FIG. 5) may shift far away from the maximum steady stress location 32. The combination stress at both maximum vibratory stress location 31 and maximum steady stress location 32 decreased to the level that blade has longer fatigue life. It will be appreciated that these values in FIGS. 5-6 are only for illustrative purposes and the exact values will vary based on the actual geometry of turbine wheel 10 and the operation conditions of the turbine engine.

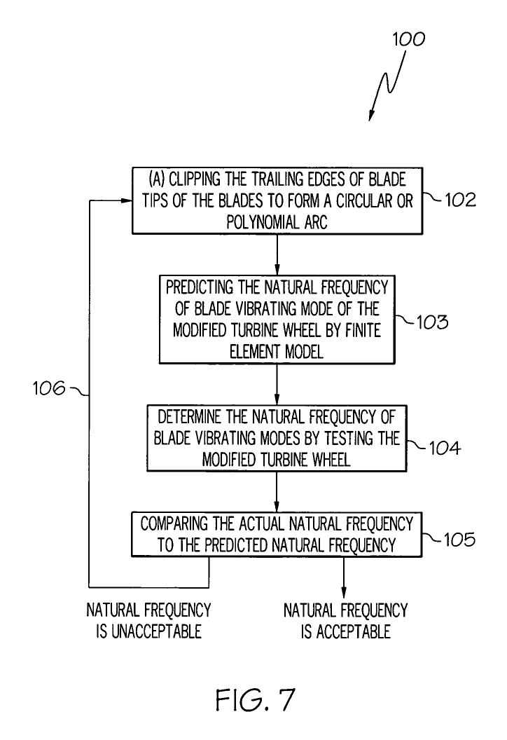

The present invention also provides a method 100 (FIG. 7) for increasing the natural frequency in a blade vibration of a turbine wheel. Method 100 may comprise step 102 of clipping the trailing edges of blade tips of turbine wheel blades to form a circular or polynomial arc followed by step 103 of predicting the natural frequencies of blade vibration by a finite element model, step 104 of determining the actual natural frequencies of blade vibration by testing the modified turbine wheel and step 105 of comparing the actual natural frequency to the predicted natural frequency. If the actual natural frequency is of an acceptable level compared to the predicted natural frequencies, no further steps may be required. If the actual natural frequency is still below a predetermined acceptable level, steps 102, 103, 104, and 105 may be repeated (step 106) until an acceptable actual frequency is obtained. For example, an acceptable actual frequency may be, but not limited to, from 5 per revolution to 17 per revolution or from 11 per revolution to 17 per revolution.

It should be understood, of course, that the foregoing relates to exemplary embodiments of the invention and that modifications may be made without departing from the spirit and scope of the invention as set forth in the following claims.

We claim:

1. A turbine wheel comprising:
a hub;
a central bore running longitudinally through the hub;
at least one blade, the blade extending radially from the hub and wherein the blade comprises a blade tip, the blade tip comprising a trailing edge; and
wherein the trailing edge of the blade tip is locally curved.

2. The turbine wheel of claim 1 wherein the turbine wheel further comprises long and short splitters.

3. The turbine wheel of claim 1 wherein the turbine wheel comprises at least five blades.

4. The turbine wheel of claim 3 wherein the turbine wheel comprises at least five long splitters and at least ten short splitters.

5. The turbine wheel of claim 1 wherein the curvature of the trailing edge of the blade tip is a circular or polynomial arc.

6. The turbine wheel of claim 1 wherein the curvature of the trailing edge of the blade tip is defined by: R=aₙ×Zⁿ+aₙ₋₁×Zⁿ⁻¹+b, where Z is an axial coordinate of a shroud line, R is a radial coordinate of the shroud line, n is an order of polynomial n=2, 3, 4 . . . , and aₙ and b are constants.

7. A turbine wheel comprising:
a hub;
a central bore running longitudinally through the hub;
long splitters and short splitter, the long and short splitters extending radially from the hub;
a plurality of blades, the blades extending radially from the hub and being separated from one another by the long and short splitter, wherein the blade comprises a blade tip, the blade tip comprising a trailing edge; and
wherein the trailing edge of the blade tip is curved.

8. The turbine wheel of claim 7 wherein the curvature of the trailing edge of the blade tip is a circular or polynomial arc and wherein the curvature of the trailing edge of the blade tip is defined by: R=aₙ×Zⁿ+aₙ₋₁×Zⁿ⁻¹+ . . . +a×Z+b, where Z is an axial coordinate of a shroud line, R is a radial coordinate of the shroud line, n is an order of polynomial n=2, 3, 4 . . . , and aₙ and b are constants.

9. The turbine wheel of claim 7 wherein the turbine wheel is part of a gas turbine engine.

10. The turbine wheel of claim 9 wherein the gas turbine engine is part of an aircraft.

11. A method for increasing the natural frequency in a blade vibrating mode of blades of a turbine wheel comprising the steps of:
(a) clipping the trailing edges of blade tips of the blades to form a circular or polynomial arc;
(b) predicting the natural frequency of blade vibrating modes by using a finite element model of the modified turbine wheel;
(c) determining the actual natural frequency of blade vibration modes by testing the modified turbine wheel; and
(d) comparing the actual natural frequency to the predicted natural frequency.

12. The method of claim 11 further comprising step (e) of repeating steps (a) (b), (c) and (d) when in step (d) the actual natural frequency is acceptable when compared to the predicted natural frequency.

13. The method of claim 11 wherein the natural frequency of the first blade bending mode of step (c) is from about 5 per revolution to about 17 per revolution.

14. The method of claim 11 wherein the natural frequency of the second blade torsional mode of step (c) is from about 11 per revolution to about 17 per revolution.
